(19) United States
(12) Patent Application Publication
(10) Pub. No.: US 2024/0303586 A1
(43) Pub. Date: Sep. 12, 2024

(54) SYSTEM AND METHOD FOR VEHICLE TRANSPORTATION SCENARIO GENERATION AND SEARCHING

(71) Applicants: US Venture Futures, LLC, Madison, WI (US); U.S. Venture, Inc., Appleton, WI (US)

(72) Inventors: Jeffrey Lang, Madison, WI (US); Brett M. Wetzel, Green Bay, WI (US); Michael L. Koel, De Pere, WI (US); Craig Dickman, Green Bay, WI (US)

(73) Assignees: US Venture Futures, LLC, Madison, WI (US); U.S. Venture, Inc., Appleton, WI (US)

(21) Appl. No.: 18/563,742

(22) PCT Filed: May 25, 2022
(86) PCT No.: PCT/US2022/030913

§ 371 Date: Nov. 22, 2023

Related U.S. Application Data
(60) Provisional application No. 63/193,444, filed on May 26, 2021.

(51) Int. Cl. G06Q 10/0834; G06Q 30/018

(52) U.S. Cl. CPC G06Q 10/0834; G06Q 30/018

(57) ABSTRACT

A system for vehicle transportation operates to receive decision data indicating decisions for transportation of cargo from one or more originating locations to one or more destination locations by one or more vehicles, wherein the one or more vehicles are configured to transport between the originating locations and the one or more destination locations by operating one or more tractive components of the one or more vehicles. The system operate to generate a plurality of scenarios, by generating a baseline scenario including a plurality of decisions indicated by the decision data, performing a plurality of modifications to the baseline scenario by making one or more adjustments to the plurality of decisions of the baseline scenario, and saving the modifications of the baseline scenario as the plurality of scenarios. The system operate to determine emissions production resulting from the plurality of scenarios and generate one or more updates to the transportation.

### CROSS-REFERENCE TO RELATED PATENT APPLICATION

This application claims the benefit of, and priority to, U.S. Provisional Application No. 63/193,444 filed May 26, 2021, the entirety of which is incorporated by reference herein.

### BACKGROUND

The present disclosure relates generally to transportation based decision making. Vehicles such as trucks, vans, trains, airplanes, boats, cars or any other type of vehicle can carry cargo (e.g., shipments, personnel, drivers, products, etc.). However, the complexity and volume of all the possible transportation decisions are computationally difficult to determine by a computing system or understand by an operator.

### SUMMARY

One implementation of the present disclosure includes a system including one or more memory devices storing instructions thereon that, when executed by one or more processors, cause the one or more processors to receive decision data (e.g., actual vehicle data). The decision can indicate decisions for transportation of cargo from one or more originating locations to one or more destination locations by one or more vehicles, wherein the one or more vehicles are configured to transport between the originating locations and the one or more destination locations by operating one or more tractive components of the one or more vehicles. The instructions cause the one or more processors to generate scenarios, by generating a baseline scenario including decisions indicated by the decision data, performing modifications to the baseline scenario by making one or more adjustments to the decisions of the baseline scenario, and saving the modifications of the baseline scenario as the scenarios. The instructions cause the one or more processors to determine emissions production resulting from the scenarios, generate one or more updates to the transportation based on the scenarios and the emissions production resulting from the scenarios, and output the one or more updates to the transportation to an output device.

In some embodiments, the instructions cause the one or more processors to generate data that programs one or more autonomous or semi-autonomous vehicles causing the one or more autonomous or semi-autonomous vehicles to perform the transportation.

In some embodiments, the instructions cause the one or more processors to generate a user interface including the one or more updates and cause a display device of a user device to display the user interface.

In some embodiments, the instructions cause the one or more processors to perform the modifications to the baseline scenario by adjusting fuel types, fuel sources including at least one of private fuel sources or public fuel sources, transportation types including at least one of truck transportation, air transportation, boat transportation, rail transportation, or any other type of transportation, transportation equipment indicating a type of equipment used to carry the cargo, and transportation equipment fill indicating an amount of the cargo included within transportation performed with the transportation equipment.

In some embodiments, the instructions cause the one or more processors to generate a digital twin based on the decision data, the digital twin representing the baseline scenario. In some embodiments, the instructions cause the one or more processors to perform the modifications to the baseline scenario by modifying the digital twin.

In some embodiments, the emissions production is a total emissions indicating operational emissions, feedstock emissions, and fuel production emissions.

In some embodiments, the emissions production is an emissions intensity.

In some embodiments, the instructions cause the one or more processors to receive a scenario that includes an update to one or more of the decisions of the baseline scenario, wherein the update is based on a user input and identify a particular emissions production resulting from the scenario.

In some embodiments, the instructions cause the one or more processors to receive an emissions level, identify one or more scenarios of the scenarios that are associated with an emissions less than the emissions level and generate the one or more updates to the transportation based on the one or more scenarios identified that are associated with the emissions less than the emissions level.

In some embodiments, wherein the instructions cause the one or more processors to determine, based on the decision data, one or more predicted actions of one or more carriers (e.g., third party/for-hire fleets, private fleets, transit fleets), analyze the scenarios with the one or more predicted actions to determine the emissions production resulting from the scenarios, and generate the one or more updates to the transportation based on the scenarios, the one or more predicted actions, and the emissions production resulting from the scenarios.

Another implementation of the present disclosure is a method including receiving, by a processing circuit, decision data indicating decisions for transportation of cargo from one or more originating locations to one or more destination locations by one or more vehicles, wherein the one or more vehicles are configured to transport between the originating locations and the one or more destination locations by operating one or more tractive components of the one or more vehicles. The method includes generating, by the processing circuit, scenarios, by generating a baseline scenario including decisions indicated by the decision data, performing modifications to the baseline scenario by making one or more adjustments to the decisions of the baseline scenario, and saving the modifications of the baseline scenario as the scenarios. The method includes determining, by the processing circuit, emissions production resulting from the scenarios, generating, by the processing circuit, one or more updates to the transportation based on the scenarios and the emissions production resulting from the scenarios, and outputting, by the processing circuit, the one or more updates to the transportation to an output device.

In some embodiments, the method includes generating, by the processing circuit, data that programs one or more autonomous or semi-autonomous vehicles causing the one or more autonomous or semi-autonomous vehicles to perform the transportation.

In some embodiments, the method includes generating, by the processing circuit, a user interface including the one or more updates and causing, by the processing circuit, a display device of a user device to display the user interface.

In some embodiments, the method includes performing, by the processing circuit, the modifications to the baseline scenario includes adjusting fuel types, fuel sources including at least one of private fuel sources or public fuel sources, transportation types including at least one of truck transportation, air transportation, boat transportation, or rail transportation, transportation equipment indicating a type of equipment used to carry the cargo, and transportation equipment fill indicating an amount of the cargo included within transportation performed with the transportation equipment.

In some embodiments, the method includes generating, by the processing circuit, a digital twin based on the decision data, the digital twin representing the baseline scenario performing, by the processing circuit, the modifications to the baseline scenario by modifying the digital twin.

In some embodiments, the emissions production is a total emissions indicating operational emissions, feedstock emissions, and fuel production emissions.

In some embodiments, the method includes receiving, by the processing circuit, an emissions level, identifying, by the processing circuit, one or more scenarios of the scenarios that are associated with an emissions less than the emissions level, and generating, by the processing circuit, the one or more updates to the transportation based on the one or more scenarios identified that are associated with the emissions less than the emissions level.

In some embodiments, the method includes determining, by the processing circuit, based on the decision data, one or more predicted actions of one or more carriers, analyzing, by the processing circuit, the scenarios with the one or more predicted actions to determine the emissions production resulting from the scenarios, and generating, by the processing circuit, the one or more updates to the transportation based on the scenarios, the one or more predicted actions, and the emissions production resulting from the scenarios.

Another implementation of the present disclosure is one or more memory devices storing instructions thereon that, when executed by one or more processors, cause the one or more processors to receive decision data indicating decisions for transportation of cargo from one or more originating locations to one or more destination locations by one or more vehicles, wherein the one or more vehicles are configured to transport between the originating locations and the one or more destination locations by operating one or more tractive components of the one or more vehicles. The instructions cause the one or more processors to generate scenarios, by generating a baseline scenario including decisions indicated by the decision data, performing modifications to the baseline scenario by making one or more adjustments to the decisions of the baseline scenario, and saving the modifications of the baseline scenario as the scenarios. The instructions cause the one or more processors to determine emissions production resulting from the scenarios, generate one or more updates to the transportation based on the scenarios the emissions production resulting from the scenarios, and output the one or more updates to the transportation to an output device.

In some embodiments, the instructions cause the one or more processors to generate a digital twin based on the decision data, the digital twin representing the baseline scenario. In some embodiments, the instructions cause the one or more processors to perform the plurality of modifications to the baseline scenario by modifying the digital twin.

In some embodiments, the scenario indicates at least one carbon offset purchase. The carbon offset purchase can offset a carbon emissions level associated with the scenario.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a system including a transportation system, according to an exemplary embodiment.

FIG. 2 is a block diagram of an emissions system of the transportation system of FIG. 1 shown in greater detail analyzing emissions data for a transporter, according to an exemplary embodiment.

FIG. 3 is a block diagram of the emissions system allowing a user to make various transportation and emission methodology selections, according to an exemplary embodiment.

FIG. 4A is a block diagram of a system performing scenario based generation and searching, according to an exemplary embodiment.

FIG. 4B is a block diagram of the system performing the scenario based generation and searching with economics information, market information, public domain information, and proprietary information, according to an exemplary embodiment.

FIG. 5 is a flow diagram of a process of performing the scenario generation and searching, according to an exemplary embodiment.

FIGS. 6-7 are a user interface including emissions data for transportation destinations, according to an exemplary embodiment.

FIG. 8 is a table providing an indication of lifecycle measurements and tailpipe measurements, according to an exemplary embodiment.

FIG. 9 is a user interface of charts comparing lifecycle emissions and tailpipe emissions, according to an exemplary embodiment.

FIG. 10 is a user interface indicating lifecycle emissions over time, according to an exemplary embodiment.

FIG. 11 is a user interface of lifecycle emissions by mode, lifecycle emissions by region, lifecycle emissions per ton-mile, and lifecycle emissions by carrier, according to an exemplary embodiment.

FIG. 12 is a user interface of lifecycle emissions by year and for transportation volume, according to an exemplary embodiment.

FIG. 13 is a user interface indicating fuel/energy consumption by transportation mode, every consumption per ton-mile, total distance by mode of transportation, and average length of a haul, according to an exemplary embodiment.

FIG. 14 is a user interface indicating transportation volume breakdowns by carrier, fuel/energy consumption breakdown by carrier, estimated core movement fuel/energy efficiency by carrier, and average load fill by carrier, according to an exemplar embodiment.

FIG. 15 is a user interface of projected lifecycle emissions and projected lifecycle emissions intensity, according to an exemplary embodiment.

FIG. 16 is a user interface of fuel/energy data and performance metrics for a transporter, according to an exemplary embodiment.

FIG. 17 is a user interface of a portfolio fuel/energy summary for a transporter, according to an exemplary embodiment.

FIG. 18 is a chart indicating emissions by transportation type for a transporter, according to an exemplary embodiment.

FIG. 19 is a user interface indicating emissions production by geographic region for a transporter, according to an exemplary embodiment.

FIG. 20 is a user interface indicating fuel/energy type usage of a transporter, according to an exemplary embodiment.

FIG. 21 is a user interface providing an overview of a transporters performance and emissions reduction recommendations for the transporter, according to an exemplary embodiment.

### DETAILED DESCRIPTION

Referring generally to the FIGURES, a system that performs transportation based scenario generation and searching is shown, according to various exemplary embodiments. The transportation system can be configured to perform an emissions based analysis of a transporter. A transporter can be an entity such as a shipper that ships cargo via a vehicle. The transporter can be a private fleet. The transporter can be an individual or company that moves cargo. The transporter can be a navigation system of a vehicle that performs navigation. The transporter could be an autonomous driving system of a vehicle or a computing system that orchestrates the travel routes of multiple vehicles. The transporter can transport cargo from one location to another. The cargo can include products, equipment, people, personnel, goods, chemicals, groceries, etc. The transportation decisions made by the transporter, e.g., decisions regarding fuel/energy type, fuel/energy source, transportation equipment, transportation mode, etc. can all have an emissions impact. The vehicles used for the transportation can include components such as motors, engines, turbines, etc. that cause the vehicles to transport between locations, e.g., a originating location to a destination location. The transportation system can analyze the shipping decisions of the transporter and provide recommendations for improving and adapting the transportation decisions of the adapter to meet cost and/or emissions based goals.

The transportation system can, in some embodiments, analyze historical transportation data of a transporter to identify a baseline (e.g., a digital twin) representing the current and/or historical transportation decisions of the transporter. In some embodiments, the transportation system can receive user input from the transporter that changes certain transportation decisions of the transporter, e.g., the fuel types used, the fuel/energy sources used, transportation equipment used, transportation mode used, etc. The transportation system can identify changes to emissions production that would result based on the changes made by the user. This feedback provided by the transportation system can help a user understand what types of changes the transporter could make to their transportation to reduce emissions production.

The possible search space of transportation decisions to transport cargo from one or more originating locations to one or more destination locations is large (e.g., thousands, millions, billions, or trillions of possible combinations of transportation decisions). Considering this large space of possible transportation decisions can require a significant amount of computational resources. For example, to compare each combination of transportation decisions against one another, a large number of combinations of transportation decisions would need to be stored (requiring a significant amount of memory utilization) and a large number of comparisons would need to be performed (requiring a significant amount of processor resources). Furthermore, storing and comparing this large amount of transportation data would require a significant run time. This long run time would require processors and memory to spend a significant amount of time in an operational state consuming large amounts of power from a power source.

To solve these and other technical problems, the technical solution described herein can include a transportation system that performs transportation based scenario generation and searching to reduce memory utilization, processor utilization, runtime, and power consumption. The transportation system can, in some embodiments, run a scenario analysis to identify and evaluate various scenarios which reduces the possible search space of transportation decisions. This solution reduces the processor resources, memory resources, and power consumption needs of the transportation system. Furthermore, this solution allows for the searching and identification of an ideal scenario quickly (e.g., faster than conventional methods). The transportation system can, via artificial intelligence, machine learning, and/or deep learning, identify scenarios. Each scenario can utilize different fuel/energy sources, shipment routes, fuel/energy sources, shipment modalities, shipping equipment, truck load, etc. The transportation system can generate the scenarios by forming a baseline scenario that indicates typical or historical transportation decisions of a transporter. The baseline scenario can be a digital twin. The transportation system can make modifications to the baseline and save each resulting modification as a new scenario. The transportation system can store (and/or learn over time) what adjustments improve baselines. The transportation system can generate the scenarios based on data stored by the transportation system indicating what modifications are likely to improve a baseline. The transportation system can further analyze the scenarios to identify emissions production resulting from each scenario. The transportation system can further generate new scenarios based on the result of the analysis of previous scenarios. The transportation system can determine improvements to a transportation of cargo indicated based on the scenarios. The transportation system can output the improvements via one or more output devices, e.g., send one or more commands to a vehicle or vehicles to perform the transportation, display the improvements to a user via a user interface, etc. In some embodiments, the transportation system can generate recommendations based on identified scenarios that meet certain goals, e.g., certain monetary and/or emissions goals, to the user via a user interface displayed on a display device of a user device.

In some embodiments, the transportation systems and methods described herein can be applied not only to transportation, but to other fuel/energy consumption related spaces. For example, building systems, manufacturing systems, laboratory systems, refrigeration systems, etc. can all utilize the systems and methods described herein for identifying improvements to emissions production and/or cost.

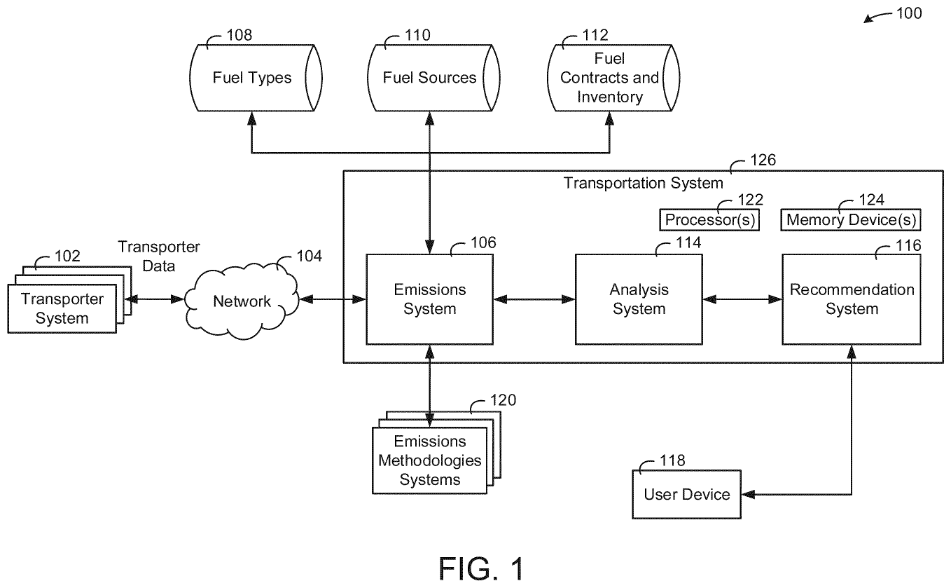

Referring now to FIG. 1, a block diagram of a system 100 including a transportation system 126 is shown, according to an exemplary embodiment. The system 100 includes a transporter system 102 (or multiple transporter systems) that communicate with the transportation system 126 via a network 104. The network 104 can be a communication network such as or including the Internet. Furthermore, the transportation system 126 further communicates with databases storing fuel types 108, fuel sources 110, and fuel contacts and inventory 112. Furthermore, the transportation system 126 can communicate with a user device 118.

The transporter system 102 can be a computer system (e.g., desktop computer, database system, server system, etc.) that is configured to communicate with the transportation system 126 via the network 104 to provide historical and/or current shipment data of the transporter system 102 to the transportation system 126 for analysis. The network 104 can be a Local Area Network (LAN), a Wide Area Network (WAN), the Internet, a cellular network, and any other type of wired or wireless form of communication. The transporter data can indicate historical shipments, e.g., fuel/energy used, fueling sources, starting locations, ending locations, fuel/energy contracts, shipping equipment used, weight of shipment, how filled the shipping equipment are during their shipments, number of shipments for various routes, carbon credits, renewable identification numbers (RINs), etc. The transporter data can be provided by the transporter system 102 periodically to the transportation system 126 and/or in real-time as the data is collected by the transporter system 102.

The transportation system 126 can be implemented on one or more computing systems, e.g., on processors and/or memory devices. The transportation system 126 can be one or more server systems, cloud computing systems, etc. For example, the transportation system 126 includes processor(s) 122 and memory device(s) 124. The processors 122 can be a general purpose or specific purpose processor, an application specific integrated circuit (ASIC), one or more field programmable gate arrays (FPGAs), a group of processing components, or other suitable processing components. The processors 122 may be configured to execute computer code and/or instructions stored in the memories or received from other computer readable media (e.g., CDROM, network storage, a remote server, etc.).

The memory device(s) 124 can include one or more devices (e.g., memory units, memory devices, storage devices, etc.) for storing data and/or computer code for completing and/or facilitating the various processes described in the present disclosure. The memory device(s) 124 can include random access memory (RAM), read-only memory (ROM), hard drive storage, temporary storage, non-volatile memory, flash memory, optical memory, or any other suitable memory for storing software objects and/or computer instructions. The memory device(s) 124 can include database components, object code components, script components, or any other type of information structure for supporting the various activities and information structures described in the present disclosure. The memory device(s) 124 can be communicably connected to the processor(s) 122 and can include computer code for executing (e.g., by the processors) one or more processes described herein.

The transportation system 126 can be configured to calculate costs and emissions for the transport of goods, people, produce, products, equipment, resources, etc. for businesses, manufacturers, retailers, etc. Furthermore, the transportation system 126 can, in some embodiments, calculate costs and emissions for building operation. Furthermore, the transportation system 126 can, in some embodiments, calculate emissions costs for transportation of employees of a business. The transportation system 126 can be used to claim emissions credits and offsets based on emissions calculations made by the transportation system 126.

The shipment data can be received by an emissions system 106. The emissions system 106 can be configured to analyze the transporter data and identify emissions created by various shipments indicated by the transporter data. The emissions determined by the emissions system 106 can be carbon intensity scores, carbon dioxide production levels, methane production levels, nitrous oxide production levels, fluorinated gases production, etc. The emissions system 106 can receive fuel type information from the database 108, fuel source information from the database 110, and fuel contacts and inventor information from the database 112. In some embodiments, the emissions system 106 can generate the emissions calculation based on the information received from the databases 108-112.

Furthermore, the emissions system 106 can receive emissions calculation methodologies from the systems 120. The emissions systems 120 can be various systems that define a type or standard of emissions calculation for determining emissions. The emissions system 106 can generate emissions data based on the methodologies of the system 120. For example, the methodologies could be based on the emissions methodology of the Environmental Protection Agency (EPA), California Greenhouse Gases, Regulated Emissions, and Energy Use in Transportation (CA-GREET), etc.

In some embodiments, the fuel type information received from the fuel types 108 can indicate renewable natural gas (RNG), e.g., dairy RNG, landfill RNG, wastewater RNG, food/industrial RNG, etc., electric, hydrogen, diesel, renewable diesel, biodiesel, propane, thermal energy recovery, coal, gasoline, oil, wind power, any type of renewable energy etc. The emissions system 106 can be configured, based on the fuel/energy type information, to calculate emissions for various shipments based on the various types of fuel/energy. The fuel sources 110 can indicate fueling stations, e.g., public fueling stations, private fueling stations, RNG fuel sources, RNG thermal energy supplies, wind power electric sources, solar power electric sources, etc. The information can be used by the emissions system 106 to plan emissions usage for various routes for fueling at various stations.

The emissions system 106 can participate with fuel recovery programs, i.e., programs that reimburse carriers for fuel/energy costs based on emissions created by transportation. The emissions system 106 can identify emissions data for submission to the recovery programs, in some embodiments. The programs can be state run programs or continent based programs (e.g., California, North America, Europe, etc.) In some cases, the programs include ocean and/or water travel emissions.

In some embodiments, the emissions system 106 can be configured to determine emissions and fuel/energy consumption by mode of transportation and equipment, load level data for mileage tracking, load level weight, and/or volume inclusion. In some embodiments, the emissions system 106 can be configured to determine lifecycle emissions, e.g., via a lifecycle emissions model. The lifecycle emissions may indicate emissions for fuel/energy that include feedstock, fuel/energy production, and operational consumption. This is a more complete view of emissions as composed to simply operational consumption.

The analysis system 114 can be configured to generate updates for a transportation of cargo and output the updates to a device. The analysis system 114 can be configured to perform analysis to generate recommendations for the recommendation system to provide to the user device 118. The analysis system 114 can be configured to analyze the emissions data generated by the emissions system 106 to generate the recommendations, in some embodiments. For example, the analysis system 114 can be configured to analyze emissions data of the emissions system 106 to construct a route for a shipment. The analysis system 114 can identify the recommended or optimal fuel/energy type, fuel/energy sources, fueling locations, transportation modes, intermodal transportation selections, etc. for a particular requested shipment from an origin location to an ending location by the transporter system 102. The analysis system 114 can identify certain carbon offsets to utilize. In some embodiments, the analysis system 114 can identify shipping routes that pass through geographic areas associated with ideal carbon offsets allowing the transporter to save money through the carbon offsets. The analysis system 114 could generate data that programs an autonomous or semi-autonomous vehicle. The analysis system 114 could send the data to the vehicle causing the vehicle to implement a particular transportation of cargo. The data could program a travel route of the vehicle, identify the fueling locations that the vehicle should stop at during its route, identify the fuel that should be used in the vehicle, etc. Autonomous or semi-autonomous vehicles can include semi-trucks, boats, planes, trains, trucks, delivery vans, drones, etc.

In some embodiments, the analysis system 114 can analyze fuel prices by region to make shipping recommendations for the transporter system 102. The analysis system 114 can store average fuel/energy costs per region (e.g., state) and recommend fueling stops and fuel/energy types for shipments based on the average fuel/energy costs of various fuel/energy types by region.

Furthermore, the analysis system 114 can run scenario analysis for analyzing shipping scenarios. The emissions system 106 can be configured to determine a baseline and/or digital twin representing current shipping decisions of the transporter system 102. The analysis system 114 can explore various scenarios with changes or modifications made to the current shipping decisions of the transporter system 102 and/or additional shipping decisions. The analysis system 114 could store each set of transportation decisions that result from the modifications as a scenario. The analysis system 114 could store the scenarios on the memory devices 124. The various scenarios can improve or reduce the performance of shipping cost and/or emissions production. The analysis system 114 can implement various forms of machine learning, e.g., neural networks, Bayesian models, decision trees, support vector machines, etc. to identify the various scenarios. Furthermore, in some embodiments, the analysis system 114 can perform an optimization (e.g., linear programming optimization) to identify scenarios that meet certain efficiency and/or cost goals.

Further, in some embodiments, the analysis system 114 can allow a user to define scenarios that change the established baseline and/or digital twin representing current shipping decisions of the transporter system 102. The analysis system 114 can receive input from the user device 118 (e.g., via the recommendation system 116) and make predictions regarding emissions production and/or cost that result from changes to shipping specified by the input. In some embodiments, the analysis system 114 can receive operating goals from the user device 118, e.g., fuel/energy operating goals, emissions operating goals, cost operating goals, etc. and can continuously provide shipping recommendations to meet the goals provided by the user device 118.

The recommendation system 116 can present recommendations to a user, e.g., a representative of the transporter system 102. The recommendations can be provided to a user via the user device 118. The recommendations can be provided in a graphical user interface displayed on a display device of the user device 118. The user interface can indicate an emissions baseline report, visualizations, include sorting and filtering, etc. Furthermore, the recommendations can provide transportation lifecycle management including strategy development, strategic freight sourcing, and/or routing guidance.

The user device 118 can be any type of user device that displays information to, and receives input from, the user device. The user device 118 can be a smartphone, a tablet, a desktop computer, a laptop, a console, or any other type of computing device.

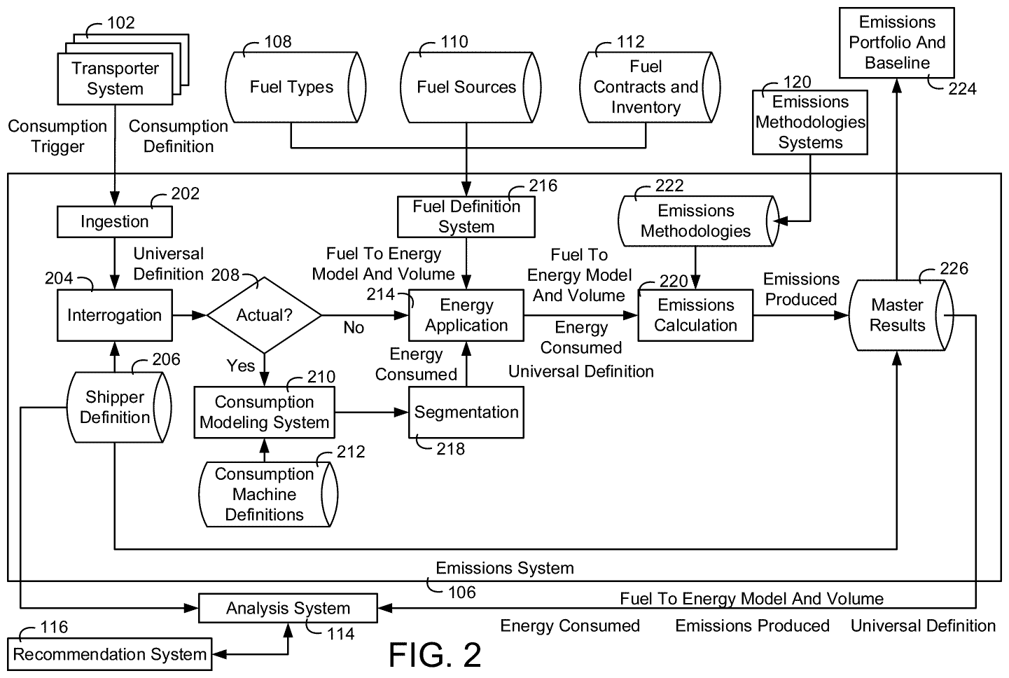

Referring now to FIG. 2, the emissions system 106 is shown in greater detail analyzing emissions data for a transporter, according to an exemplary embodiment. The emissions system 106 receives consumption data from the transporter system 102, e.g., a consumption trigger, a consumption definition, etc. The emissions system 106 receives the shipping data and ingests the data via an ingestion component 202 and formats the data into a common format, e.g., a universal definition.

The emissions system 106 receives the universal definition and interrogates the data against a transporter definition with interrogation element 204. The emissions system 106 can determine whether the data indicates fuel/energy consumption data or not element 208. If the data is not actual consumption data, the data can be provided to the energy application 214. If the data is actual consumption data, the data can be provided to the consumption modeling system 210.

The consumption modeling system 210 can analyze the consumption data received from the transporter system 102 to determine fuel/energy consumption. The consumption modeling system 210 can model various pieces of shipping equipment (e.g., trucks, rail, air, etc.) with consumption machine definitions 212 to determine the fuel/energy consumed for a particular shipment or set of shipments, e.g., shipment of goods from one location to another location for a particular weight of goods, particular equipment, particular stops, etc. The segmentation 218 can segment the fuel/energy consumed and provide the segmented data to the energy application 214.

The energy application 214 can receive information regarding fuel types, fuel sources, fuel contracts and inventory, etc. from databases 108-112. A fuel definition system 216 can determine a fuel to energy model and volume. The fuel to energy model can be used by the energy application to determine energy consumption for the data provided by the transporter system 102. The fuel to energy model and volume, along with the energy consumed, and the universal definition can be provided to the emissions calculation 220. The emissions calculation 220 can, according to various different emission methodologies 222, determine emissions for the transporter system.

The emissions calculation 220 can determine the emissions produced by the transporter system 102 based on the fuel to energy model and volume as well as the energy consumed and/or the universal definition. The emissions produced can be provided to a master results database 226 which can feed an emissions portfolio and baseline 224 which can form a picture of the emissions production of the transporter system 102 at a current point in time (or for a historical period of time). The master results 226 can further receive transporter definition data from the transporter definition database 206. The information of the master results 226 can be provided to the analysis system 114 for analysis.

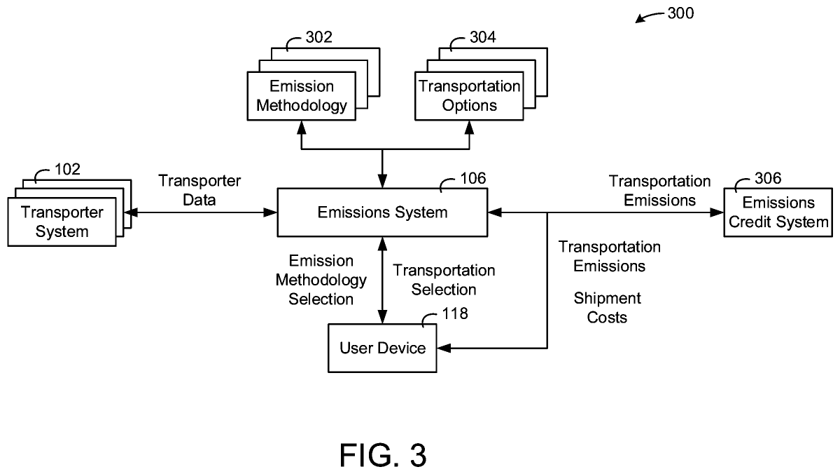

Referring now to FIG. 3, the emissions system 106 allowing a user to make various transportation and emission methodology selections is shown, according to an exemplary embodiment. In FIG. 3, the emissions system 106 receives transporter data from the transporter system 102. The emissions system 106 can convert the transporter data into a baseline, e.g., a digital twin indicating the current behavior, costs, and emissions produced by the transporter. The baseline can be the emissions portfolio and baseline 224 described in FIG. 2.

The emissions system 106 can further receive selections from the user device 118. The selections can be a selection of an emission methodology 302 and/or a transportation option 304. For example, the emission methodology can be a method for calculating emissions produced according to one set of standards, e.g., standards set by an emissions credit system 306. The transportation options 304 can be options to utilize different shipping techniques, for example, ship more products via rail instead of a trailer, utilize electric fuel/energy instead of fossil fuel, etc. The transportation options 304 can be selections of transportation modes, shipping equipment, load fill (e.g., 80% truck fill, 90% truck fill), fuel/energy types, etc.

The user, via the user device 118 can provide various selections of emission methodology and/or transportation options to the emissions system 106 and receive updated shipment emissions and/or shipment costs. In this regard, the user is able to test out multiple scenarios to see how emissions and/or transportation costs would have been had different transportation options been used and/or different transportation methodologies used. In some embodiments, the emission methodology can be used to identify transportation emissions for submission to an emissions credit system 306 that issues credits (e.g., tax breaks, financial rewards, etc.).

In some embodiments, the transporter data and/or energy/fuel information can be stored in a blockchain (e.g., a hyperledger-based blockchain). Fuel/energy producers, fuel stations, transportation operators, etc. can all place shipping data in the blockchain. In some embodiments, the emissions credit system 306 can verify the emissions calculations of the emissions system 106 by analyzing the data of the blockchain. The blockchain can provide a verifiable record of transporter data that can support an emissions credit claims, renewable energy credits, forestry credits, wind or solar credits, etc. for various regions, e.g., California, North America, Europe, etc. In some embodiments, recommendations made by the transportation system 126 can recommend fuel/energy types or transportation modes, shipping regions, etc. in order to take advantage of emissions credits.

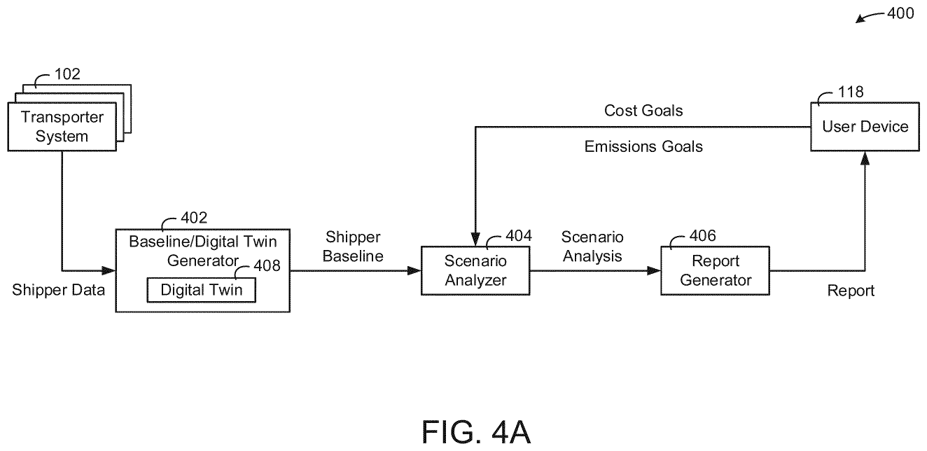

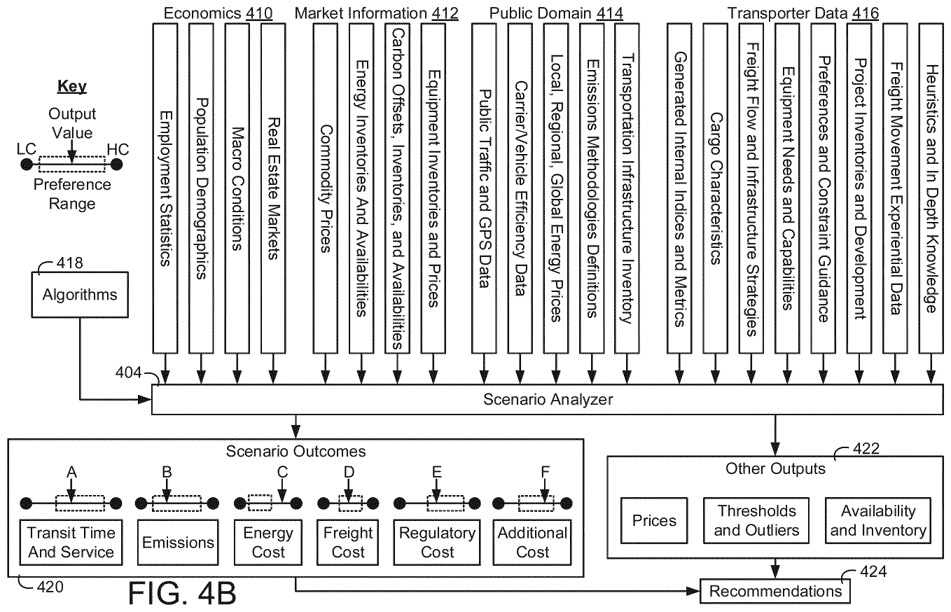

Referring now to FIG. 4A, a system 400 performing scenario based generation and searching is shown, according to an exemplary embodiment. The components of the system 400, e.g., the baseline/digital twin generator 402, the scenario analyzer 404, and the report generator 406 can be components of the transportation system 126. The baseline/digital twin generator 402 can be configured to construct a digital twin 408 that provides a baseline indication of the current shipping decisions and preferences of the transporter system 102.

The baseline/digital twin generator 402 can generate the digital twin 408 based the transporter data received from the transporter system 102. The generator 402 can identify emissions and fuel/energy costs resulting from the various shipping decisions of the transporter system 102, e.g., as described in FIGS. 1-2. The emissions can be included in the digital twin 408. The digital twin 408 can be the same as or similar to the emissions portfolio and baseline 224 described with reference to FIG. 2. Because the digital twin 408 provides an indication of current emissions, fuel/energy, and/or cost, the scenario analyzer 404 (or a user) can make improvements to the behavior of the transporter. The generator 402 can identify all transportation emissions throughout owned and outsourced fleets.

The scenario analyzer 404 can be configured to improve and/or optimize the baseline. In some embodiments, the scenario analyzer 404 can identify scenarios that provide real-time, actionable insights to generate emission savings, e.g., by highlighting routes most suitable for alternative fuel/energy, along with intermodal and carrier recommendations to support execution. The scenario analyzer 404 can analyze the digital twin 408 to identify scenarios that utilize different shipping equipment, fuel/energy types and sources, combinations of transportation modes, etc. and determine a resulting emissions and/or cost resulting from the scenario. The scenarios can further include various levels of load fill (e.g., how filled a trailer or rail car is), carrier choices, mode choices, fuel/energy type choices, carbon offsets, deadhead reduction, etc.

The scenario analyzer 404 can generate a set of scenarios, analyze the scenarios, and then utilize improvements identified in the scenarios to emissions and/or cost to generate additional scenarios. The scenario analyzer 404 can search for scenarios that meet cost goals and/or emissions goals of the transporter, the goals received from the user device 118.

The result of the scenario analysis, e.g., scenarios that a user may want to accept and implement in their shipping, can be provided to the user device 118 as part of a report. This report can provide transportation emissions reduction in a recommendations/roadmap phase. The report generator 406 can generate a report that provide optimizations that consider both emissions improvements and the economics involved with these decisions.

Referring now to FIG. 4B, the scenario analyzer 404 performing the scenario generation and searching with economics information 410, market information 412, public domain information 414, and transporter data 416 is shown, according to an exemplary embodiment. The economics information 410 include information such as employment statistics, population demographics, macro-economic conditions, real estate market information, etc. The market information 412 includes commodity prices, fuel/energy inventories and availabilities, carbon offsets, inventories, and availabilities, equipment inventories and prices, etc. The public domain information 414 includes public traffic and global positioning system (GPS) data, carrier/vehicle efficiency data, local, regional, and global fuel/energy prices, emissions calculation definitions, transportation infrastructure inventory, etc. The transporter data 416 includes generated internal indices and metrics of a transporter, cargo characteristics, freight flow and infrastructure strategies, equipment needs and capabilities, preferences and constraint guidance, project inventories and development, freight movement experiential data, heuristics and in depth knowledge, etc.

The scenario analyzer 404 can be configured to receive the information 410-416 as an input and utilize the information 410-416 to determine scenario outcomes 420. The scenario outcomes 420 can indicate information resulting from a specific combination of the inputs to the scenario analyzer 404. In some cases, a user can, via user input provided via the user device 118, change the inputs to the scenario analyzer 404 to determine new projected scenario outcomes 420. This allows a user to test various scenarios. The scenario outcomes 420 can include transit time and service, emissions, fuel/energy cost, freight cost, regulatory cost, and/or additional cost. The scenarios can further indicate carbon offsets for individual movements, lanes, customer shipments, etc. This level of specificity in the scenario analysis regarding carbon offsets can help transporters to more pointedly report emission reduction impacts to specific business objectives or needs.

In some embodiments, the scenario analyzer 404 generates a plurality of scenarios and searches for scenarios that result in particular scenario outcomes 420, i.e., certain scenario outcomes which may be specified by a user. For example, a user could set a lower constraint (LC), a high constraint (HC), and a preference range for one or more or multiple of the scenario outcomes 420. The scenario analyzer 404 can be configured to identify one or multiple scenarios that meet the user specified scenario outcomes 420.

In some cases, the scenarios analyzed by the scenario analyzer 404 is exponentially large. The scenario analyzer 404 can analyze scenarios with the algorithms 418. The algorithms 418 can be models, e.g., energy prediction models, emissions prediction models, shipping models, etc. that predict future values and ranges for the scenario outcomes 420. The scenario analyzer 404 can continually run scenarios with varied inputs with the algorithms to identify beneficial outcomes, i.e., scenarios with beneficial emissions results, fuel/energy cost, freight cost, etc.

The scenario analyzer 404 can further output other outputs 422, e.g., prices, thresholds and outliers, availability and inventory, etc. The scenario outcomes 420 and the other outputs 422 can be used to generate recommendations 424. In some embodiments, the report generator 406 receives the scenario outcomes 420 and the other outputs 422 and generates the recommendations 424 for display on the user device 118 based on the scenario outcomes 420 and the other outputs 422.

The scenario analyzer 404 can generate various scenarios with varying scenario outcomes 420 that allow a user to identify how changes made to the inputs to the scenarios affect outputs. This can allow a transporter to identify what will happen if they make changes to their shipments. This can allow the transporter to identify what changes will be beneficial before making actual changes.

For example, given actual economic conditions, a transporter may want to understand how total shipping cost would change if they switched a shipping lane from diesel fuel to compressed natural gas. The scenario analyzer 404 can receive information about the current economic conditions, natural gas fueling prices, natural gas fueling locations, carbon credits resulting from using natural gas, shipping equipment that utilizes natural gas, shipping equipment costs, etc. The scenario analyzer 404 can run the scenario and generate the corresponding scenario outcomes 420. The scenario analyzer 404 can generate the scenario outcomes 420 that are dependent upon availability of shipping partners that include equipment that runs on natural gas and access to the fueling stations for natural gas.

For example, given actual economic conditions, a transporter may want to know the most cost effective option to ship a product while reducing emission by 25% for a fiscal year assuming a certain percentage growth in total shipments. The constraints, e.g., reducing emissions by 25%, finding optimal cost, etc. while considering actual economic conditions and the particular shipment growth. The scenario analyzer 404 can identify a scenario with a scenario outcome 420 that meets the constraints of the transporter while adhering to economic constraints such as market availability, infrastructure readiness, investment boundaries, etc.

As another example, given actual economic conditions, live fuel/energy pricing, and an existing emissions reduction strategy of a transporter which includes offsets available within a certain price range, the scenario analyzer 404 can run a scenario analysis. The scenario analysis can identify how various shipping solutions will affect the availability of offsets.

In some embodiments, the scenario analyzer 404 runs on a transporter baseline or digital twin which represents the current shipping decisions of the transporter. In some embodiments, the scenario analyzer 404 can run an analysis on actual client transactions as a proxy for historical or live base demand. The scenario analyzer 404 can adjust the proxy set based upon adjustments to the economic environment. Examples could be a rapidly expanding economy, shifting demographics, or regulatory impacts. The scenario analyzer 404 can model a transporters future depending upon which factors prove out to be true.

In some embodiments, the scenario analyzer 404 can identify a baseline performance that indicates baseline emissions production from current decisions of a transporter by analyzing transporter data received from the transporter system 102. The scenario analyzer 404 can receive changes and updates to underlying transporter assumptions of the baseline performance that create new scenarios. The scenario analyzer 404 can run the new scenarios and identify emissions production from the new scenarios. The new scenarios can include updates to shipping decision, economic conditions, market information, etc. In some embodiments, the scenarios are generated by the scenario analyzer 404 based on identified patterns of behavior of a transporter and/or carrier, e.g., shipping decision preferences that the transporter and/or carrier may have.

In some embodiments, the scenario analyzer 404 can run the scenario analysis based on identified shipping preferences and/or carrier preferences of a carrier. The scenario analysis 404 can consider the normal patterns of decision making of the transporter and/or carrier in the scenarios based on the identified transporter preferences and/or carrier preferences. The scenario analyzer 404 can generate the recommendations 424 based on the transporter preferences and/or carrier preferences. In some embodiments, the scenario analyzer 404 can generate scenarios for a specific carrier, e.g., one scenario for multiple carriers. Each scenario can identify emissions, cost, etc. associated with the normal preferential decisions made by the carrier. The recommendations 424 can identify one or multiple carriers that should be selected by the transporter based on emissions and/or cost goals of the transporter. In some embodiments, the recommendations 424 can identify one or multiple fuel/energy suppliers with specific attributes (e.g., fuel/energy type, carbon intensity score, etc.) and allow the transporter to select the appropriate fuel/energy supplier.

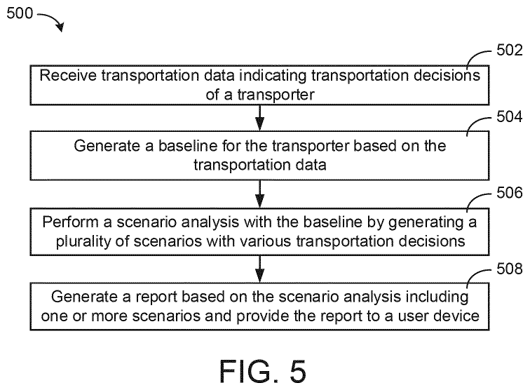

Referring now to FIG. 5, a process 500 of performing the scenario generation and searching is shown, according to an exemplary embodiment. The process 500 can be performed by the transportation system 126 described with reference to FIGS. 1-4. In some embodiments, the process 500 is performed by the components shown and described in FIG. 4A.

In step 502, the baseline/digital twin generator 402 receives transporter data indicating transportation decisions of a transporter. The transportation data can indicate historical shipping routes, the shipping equipment used, the shipment modes used, the fuel/energy used, the fueling stations used, etc. The transportation data can be collected from one or a variety of data sources by the baseline/digital twin generator 402. The transportation data can provide a historical view of the actions taken by a transporter over a past window of time.

In step 504, the baseline/digital twin generator 402 generates a baseline based on the transportation data received in the step 502. The baseline indicates a current emissions and/or monetary cost of the transportation decisions of the transportation data, indicating emissions and/or monetary costs associated with the various shipment plans, equipment, fuel types, etc. The baseline may, in some embodiments, be a digital twin that describes the current shipping behavior of the transporter.

In step 506, the scenario analyzer 404 performs a scenario analysis of the baseline generated in the step 504. The scenario analyzer 404 can generate multiple scenarios with various shipping decisions that modify or supplement the shipping decisions made by the transporter in the baseline. The scenarios can adjust shipping equipment used, fuel/energy types used, fuel/energy sources used, change modes of transportation (e.g., truck load to intermodal or to LTL), etc. Each scenario can be scored by the scenario analyzer 404 in terms of emissions produced and/or monetary cost. In some embodiments, the scenario analyzer 404 can generate scenarios in an attempt to meet certain levels of emissions and/or cost, e.g., levels and/or goals provided by the transporter.

In step 508, the report generator 406 can generate a report based on the scenario analysis that includes one or more scenarios and provide the report to a user device. The report can indicate various parameter changes that improve emissions and/or cost and/or indicate specific scenarios that meet goals and/or emissions and/or cost levels. In some embodiments, if a user accepts a particular scenario included in the report, the report generator 406 can automatically implement the accepted change by creating shipping and/or fuel/energy orders that meet the scenario accepted by the user.

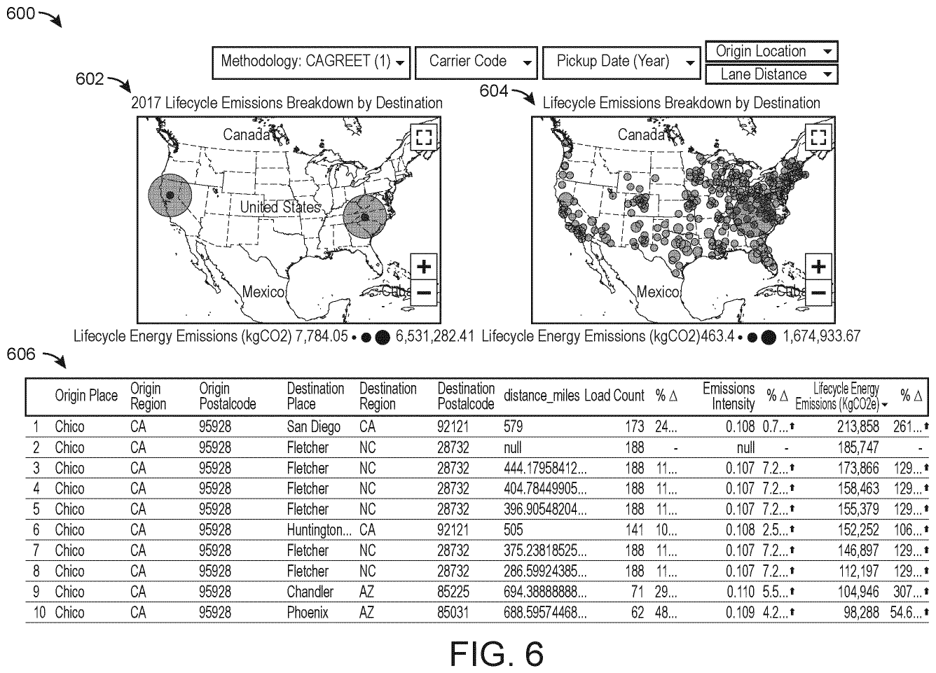

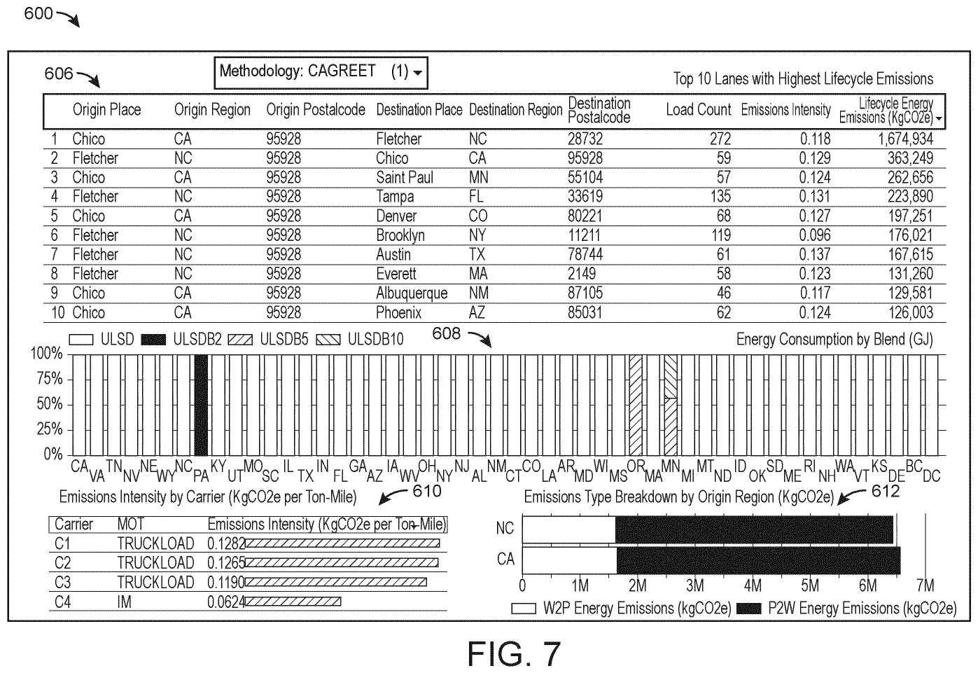

Referring now to FIGS. 6-7, a user interface 600 including emissions data for transportation between origination locations and destination locations is shown, according to an exemplary embodiment. The interface 600 can provide a visual description of a shipping baseline for a transporter. The interface 600 indicates, in elements 602 and 604, lifecycle emissions by destination for a transporter for a lifetime and/or for a particular year. Furthermore, the user interface 600 includes a table 606 that indicates certain shipping activities of a transporter. Each shipping activity indicating an origin place (city, postal code, country), destination place (city, postal code, country), shipment date, reporting region, shipping distance, loud count, emissions intensity, lifecycle fuel/energy emissions, freight type, mode of transport (less than truckload (LTL), full truck load (FTL), ocean air, etc.), vehicle type, fuel/energy type, temperature requirements, distance, brand/category, carrier/hauler, weight of the product, number of pallets, cube dimensions, customer/recipient, and trailer fill.

The user interface 600 further shows levels of ultra-low-sulfur diesel (ULSD) blends for various states in element 608. The interface 600 further includes emissions intensity per carrier used by the transporter in element 610. Furthermore, the interface 600 includes emissions type breakdowns per regions, e.g., in FIG. 7, North Carolina and California in element 612.

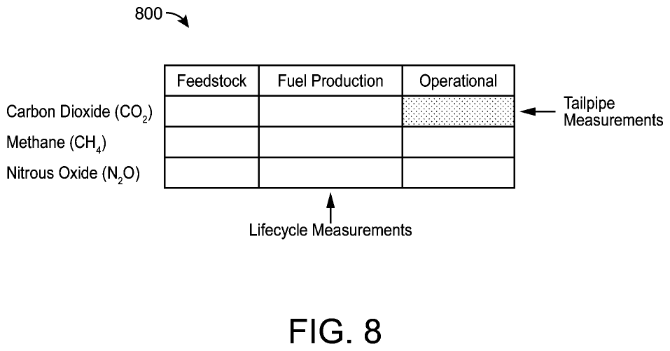

Referring now to FIG. 8, a table 800 providing an indication of lifecycle measurements and tailpipe measurements is shown, according to an exemplary embodiment. The table 800 provides an example of lifecycle measurements and tailpipe measurements that can be determined by the emissions system 106. The table 800 indicates carbon dioxide (CO2), Methane (CH4), and Nitrous Oxides (N2O) production for feedstock emissions production, fuel production emissions, and operational emissions production. The lifecycle measurements can be the sum of the feedstock, fuel production, and operational emissions productions.

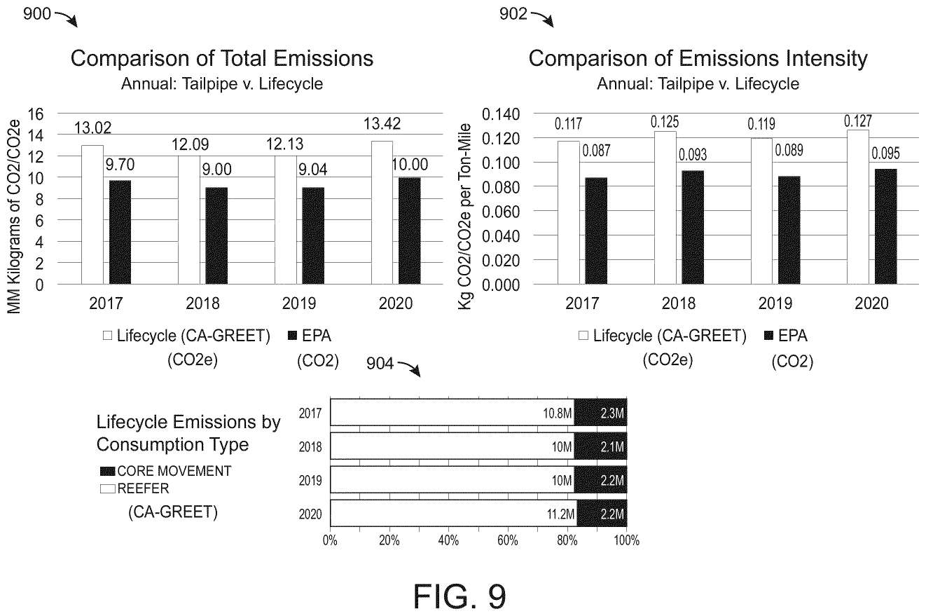

Referring now to FIG. 9, a user interface of charts 900, 902, and 904 comparing lifecycle emissions and tailpipe emissions is shown, according to an exemplary embodiment. The charts 900 and 902 can indicate emissions for a particular transporter for various past years. The chart 900 includes a comparison of total emissions calculated according to CA-GREET and EPA. The chart 902 indicates emissions intensity for CA-GREET and EPA. The chart 904 indicates lifecycle emissions by consumption type, e.g., refrigerated container (REEFER) and core shipment movements (e.g., regular or general shipping).

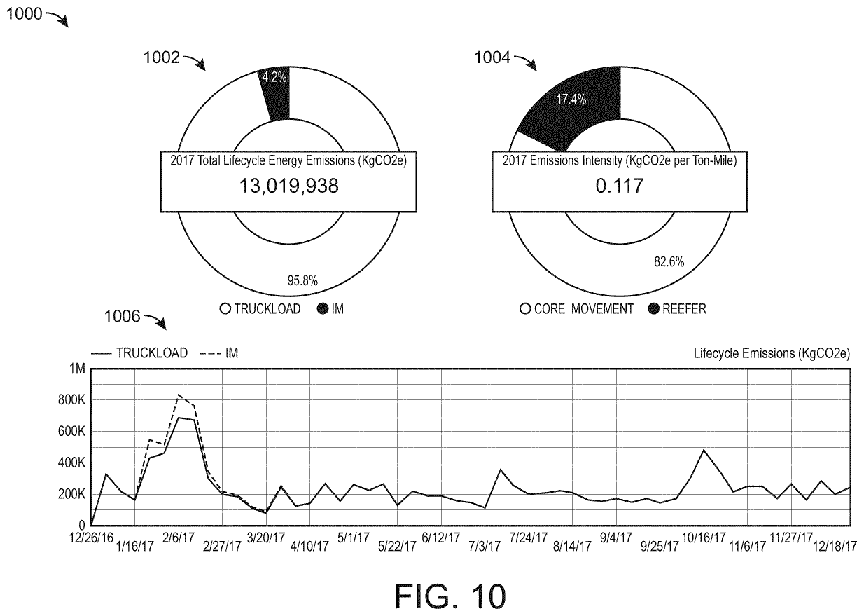

Referring now to FIG. 10, a user interface 1000 indicating lifecycle emissions over time is shown, according to an exemplary embodiment. The interface 1000 provides a chart 1002 including an indication of total lifecycle fuel/energy emissions for a shipping and a pie chart break down of total lifecycle fuel/energy emissions for Truckload (e.g., a truck shipping where the truck is dedicated to goods of one transporter) and Intermodal (IM) (e.g., shipment method where multiple shipment modalities, rail, truck, air, boat, etc. are used). Similarly, the interface 1000 includes a chart 1004 including an emissions intensity for the transporter and the contributions of emissions intensity by core movement and REEFER. The lifecycle emissions are further plotted over time in chart 1006 for truckload and IM.

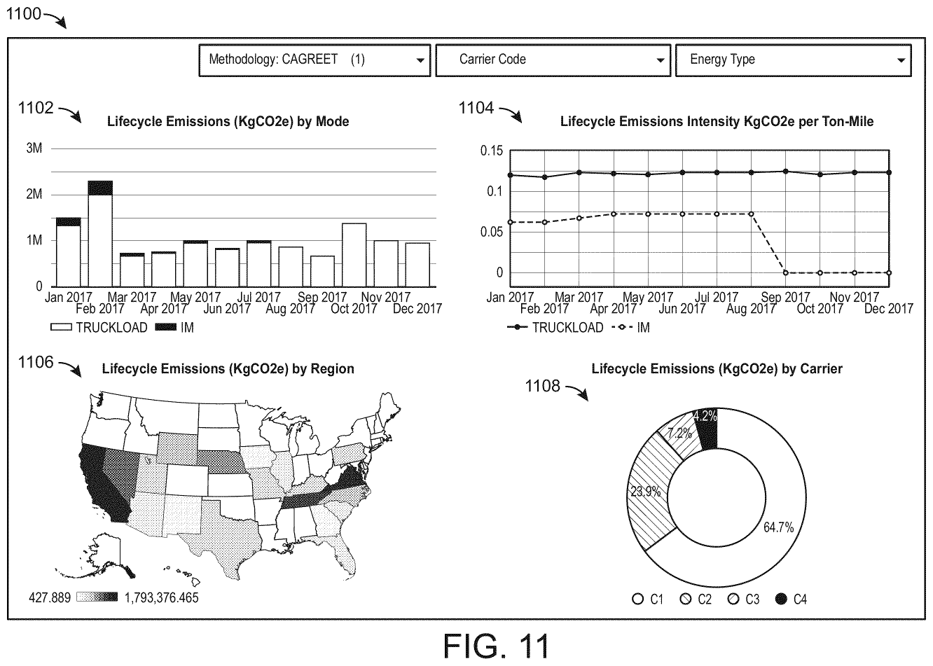

Referring now to FIG. 11, a user interface 1100 of lifecycle emissions by mode, lifecycle emissions by region, lifecycle emissions per ton-mile, and lifecycle emissions by carrier is shown, according to an exemplary embodiment. The interface 1100 includes an element 1102 indicating lifecycle emissions by transportation mode, e.g., for truckload, IM, etc. Furthermore, the interface 1100 includes an element 1104 indicating lifecycle emissions intensity per ton-mile for truck load and intermodal (IM) over time. The interface 1100 indicates lifecycle emissions by region in element 1106 which includes a map of the United States and a color of a particular darkness indicating the level of lifecycle emissions per state. The interface 1100 further includes an element 1108 indicating lifecycle emissions per carrier used by the transporter.

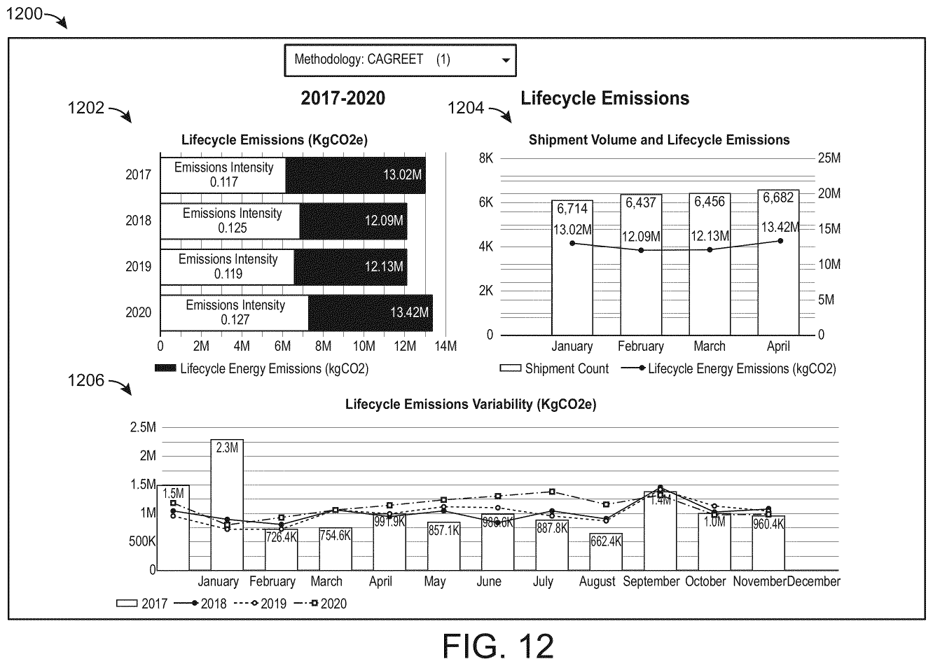

Referring now to FIG. 12, a user interface 1200 of lifecycle emissions by year and for transportation volume is shown, according to an exemplary embodiment. The interface 1200 includes an element 1202 that indicates lifecycle emissions and emissions intensity for a particular transporter for multiple years. The interface 1200 further includes an element 1204 indicating shipment volume and lifecycle emissions. The interface 1200 further includes a timeline 1206 indicating lifecycle emissions for multiple months. The timeline 1206 demonstrates the variability of lifecycle emissions by plotting the emissions of each year across the months of the timeline 1206.

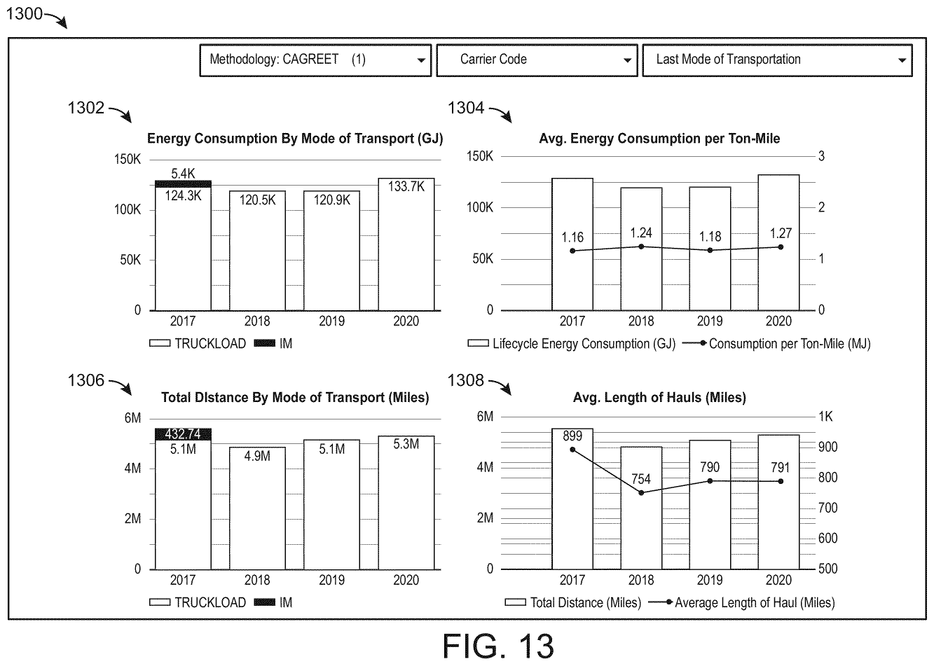

Referring now to FIG. 13, a user interface 1300 indicating fuel/energy consumption by transportation model, every consumption per ton-mile, total distance by mode of transportation, and average length of a haul is shown, according to an exemplary embodiment. The interface 1300 includes an element 1302 indicating fuel/energy consumption by mode of transport for multiple years, e.g., for truckload, IM, etc. The interface 1300 includes an element 1304 indicating average fuel/energy consumption per ton-mile for multiple years. The element 1304 indicates total lifecycle fuel/energy consumption per year and consumption per ton-mile. Furthermore, the interface 1300 includes an element 1306 indicating total distance by mode of transportation for multiple years, e.g., for truckload, IM, etc. The element 1308 indicates total distance in miles as well as the average length of hauls.

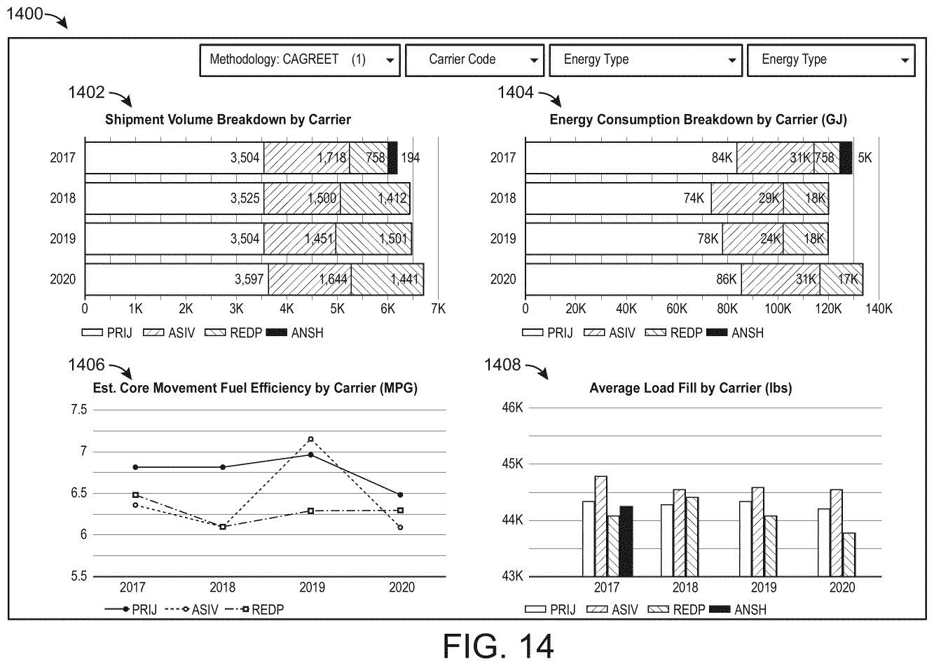

Referring now to FIG. 14, a user interface 1400 indicating shipment volume breakdowns by carrier, fuel/energy consumption breakdown by carrier, estimated core movement fuel/energy efficiency by carrier, and average load fill by carrier is shown, according to an exemplar embodiment. The interface 1400 includes an element 1402 indicating shipment volume breakdown per year by carrier used by the transporter. The interface 1400 further includes an element 1404 indicating fuel/energy consumption breakdown by carrier for multiple years. The interface 1400 further includes an element 1406 indicating core movement fuel/energy efficiency per carrier. The interface 1400 includes an element 1408 indicating average load fill. The load fill can be in in pounds per carrier per year. The load fill can be in pounds of goods per movement by carrier by year.

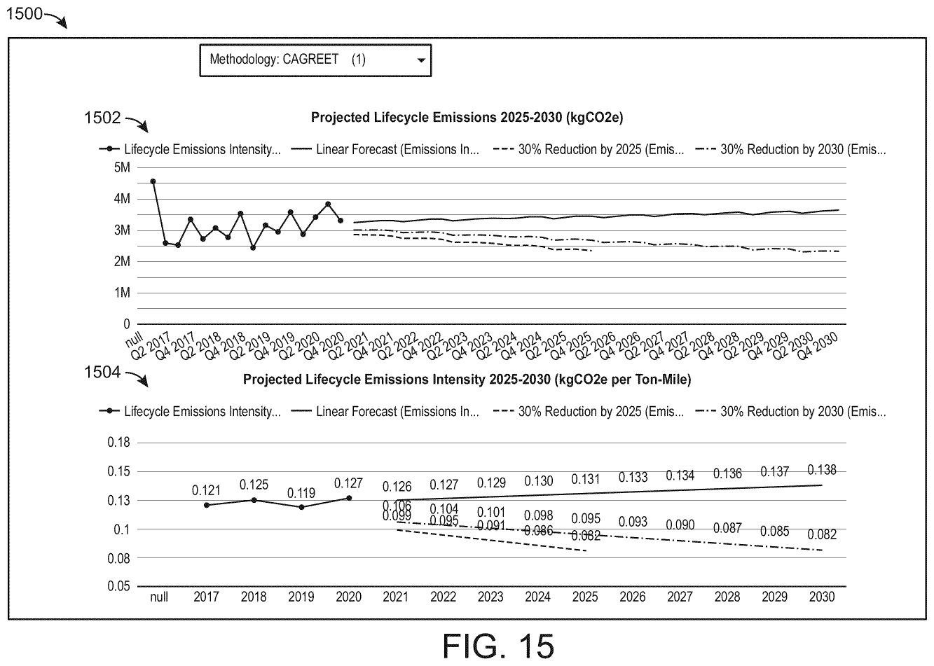

Referring now to FIG. 15, a user interface 1500 of projected lifecycle emissions and projected lifecycle emissions intensity is shown, according to an exemplary embodiment. The interface 1500 includes an element 1502 indicating projected lifecycle emissions for a transporter into the future. The projections of the element 1502 can be generated by the analysis system 114 based on an emissions baseline established by the emissions system 106. Furthermore, the element 1504 of the interface 1500 includes element 1504 indicating projected lifecycle emissions intensity projected into the future, e.g., projected by the analysis system 114 based on an emissions intensity baseline established by the emissions system 106. In some embodiments, the emissions baseline can indication emissions by product, by geographic area (e.g., state), by brand, and/or in any other emissions section. The projections can be modeled based on selected recommendations. This can help transporters understand how individual choices contribute to future potential progress.

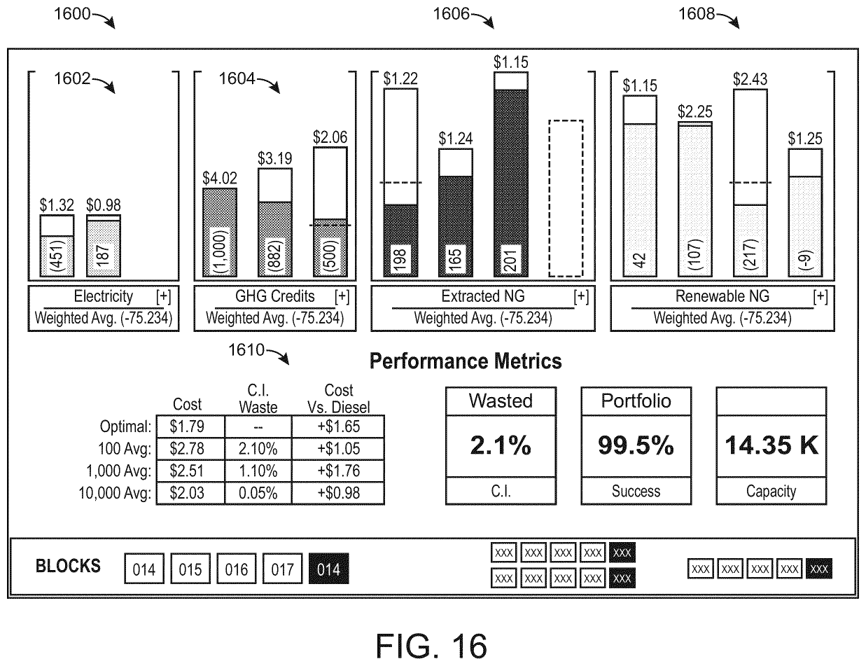

Referring now to FIG. 16, a user interface 1600 of fuel/energy data and performance metrics for a transporter is shown, according to an exemplary embodiment. The interface 1600 can be generated by the analysis system 114 from the transporter data provided by the transporter system 102. The interface 1600 includes element 1602 indicating electricity fuel/energy data, element 1604 indicating compact hydrogen generator (CHG) credits, element 1606 indicating extracted natural gas (NG) data, and element 1608 indicating renewable NG data. The interface 1600 further includes performance metrics in element 1610 indicating fuel/energy costs, carbon intensity waste, etc.

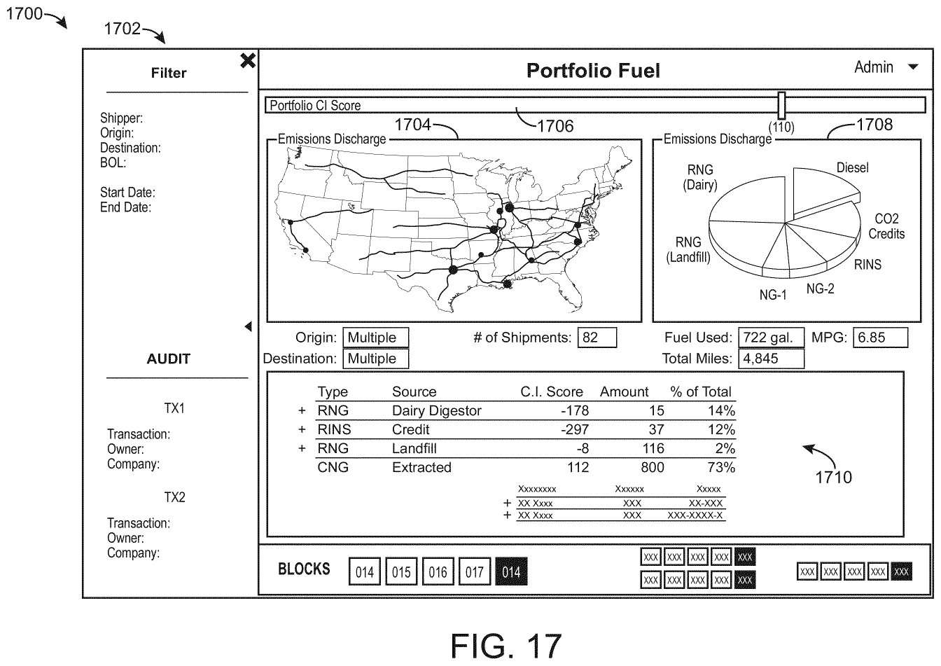

Referring now to FIG. 17, a user interface 1700 of a portfolio fuel/energy summary for a transporter is shown, according to an exemplary embodiment. The interface 1700 can be generated by the analysis system 114 from the transporter data provided by the transporter system 102. The interface 1700 includes a filter element 1702 for filtering the data displayed in the interface 1700 by transporter, origin, destination, start data, end date, etc. The element 1702 further includes an audit filter to filter the data of the interface 1702 by transaction, owner, company, etc. The interface 1700 includes a portfolio carbon intensity score element 1706 indicating a carbon intensity score for all activities of a transporter. Furthermore, the interface 1700 indicates emissions discharge by location and route in element 1704. The element 1708 of the interface 1700 indicates a portfolio blend element 1708 indicating fuel/energy sources of the transporter. The interface 1700 further includes an element 1710 indicating fuel/energy types, sources for the fuel/energy types, carbon intensity scores, etc.

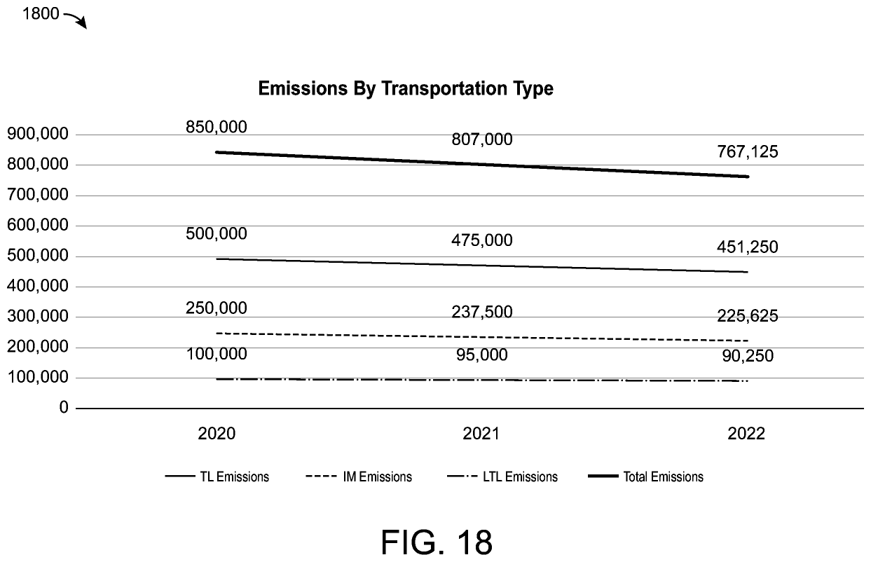

Referring now to FIG. 18, a chart 1800 indicating emissions by transportation type for a transporter, according to an exemplary embodiment. The interface 1800 can be generated by the analysis system 114 from the transporter data provided by the transporter system 102. The chart 1800 indicates emissions for a transporter by transportation type. The chart 1800 can be included within a user interface generated by the transportation system 126 and displayed on the user device 118. The chart 1800 indicates truck load (TL) emissions, intermodal (IM) emissions, less than truck load (LTL) emissions, and total emissions for the transporter.

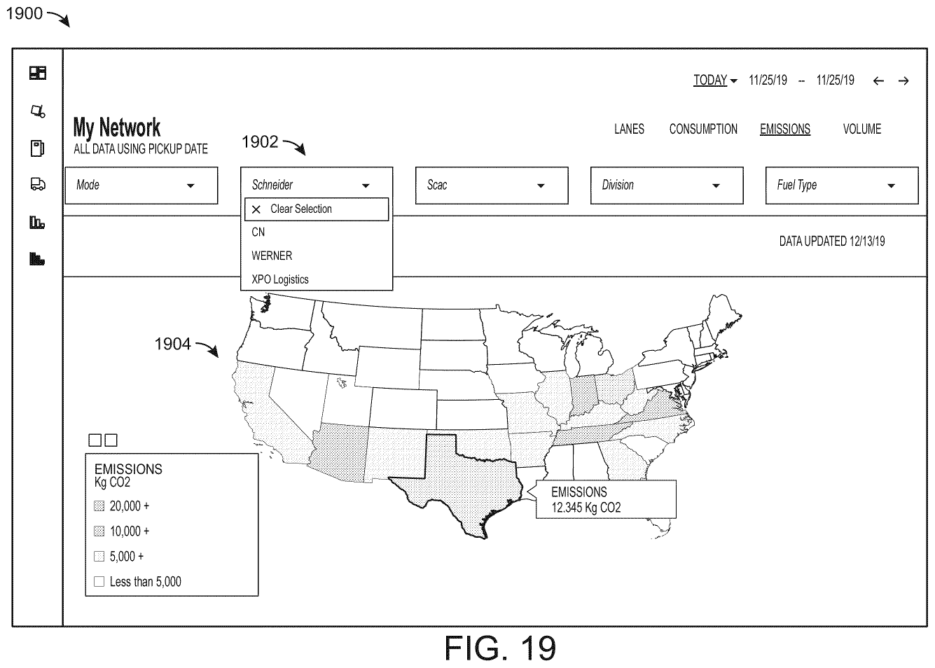

Referring now to FIG. 19, is a user interface 1900 indicating emissions production by geographic region for a transporter is shown, according to an exemplary embodiment. The interface 1900 can be generated by the analysis system 114 from the transporter data provided by the transporter system 102. The interface 1900 include a filter element 1902 for filtering the emissions production data displayed in element 1904. Element 1904 of the interface 1900 provides region based emissions totals for various geographic regions, e.g., states. The emissions totals can be emissions resulting from shipments of the transporter in the various geographic regions shown in the element 1904.

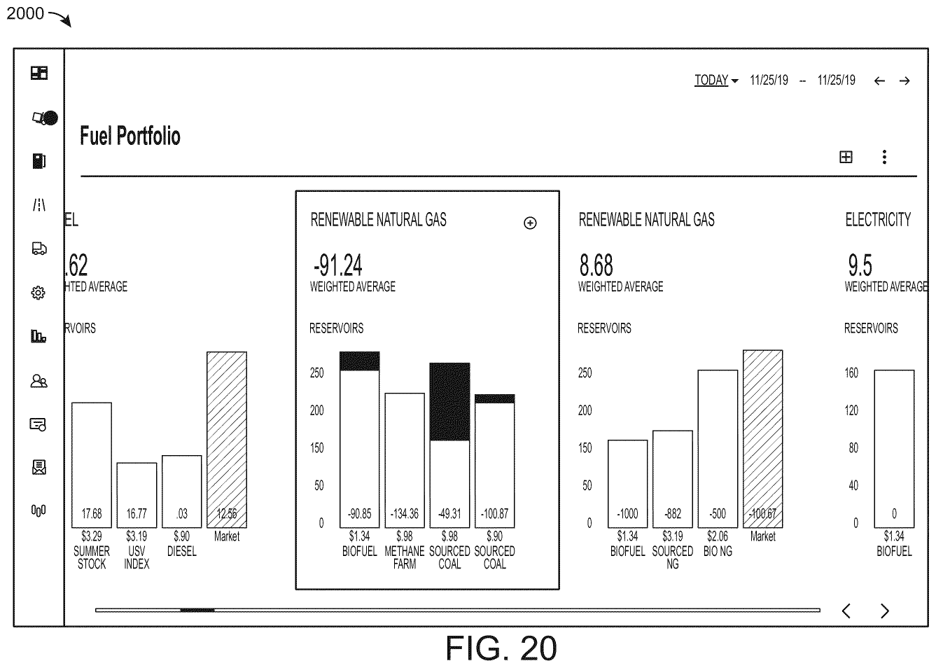

Referring now to FIG. 20, a user interface 2000 indicating fuel/energy type usage of a transporter, according to an exemplary embodiment. The interface 2000 can be generated by the analysis system 114 from the transporter data provided by the transporter system 102. The user interface 2000 provides emissions data associated with renewable natural gas, extracted natural gas, electricity, etc.

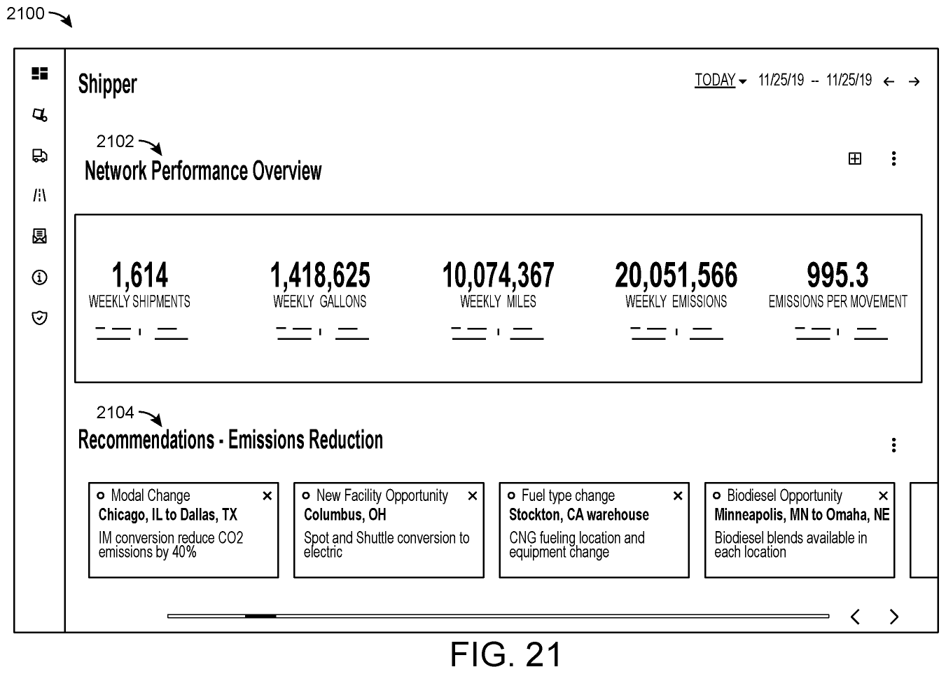

Referring now to FIG. 21, is a user interface 2100 providing an overview of a transporters performance and emissions reduction recommendations for the transporter is shown, according to an exemplary embodiment. The interface 2100 can be generated by the analysis system 114 from the transporter data provided by the transporter system 102. The user interface 2100 provides an indication of a performance overview 2102 indicating overall shipping information such as number of weekly shipments, number of weekly fuel/energy gallons consumed, number of weekly shipping miles, weekly emissions, emission per movement, etc. The interface 2100 further includes recommendations 2104 for reducing emissions. For example, the interface 2104 includes a recommendation to change a mode for a shipment from Chicago to Dallas which would result in a CO2 emissions reduction by 40%. The recommendation further includes a new facility recommendation for Columbus Ohio. The recommendations further indicate a compressed natural gas (CNG) fueling location and equipment change for a Stockton California warehouse. The recommendations further indicate that biodiesel blends are available for shipments between Minneapolis Minnesota and Omaha Nebraska.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed:

1. A system for vehicle transportation, the system comprising one or more memory devices storing instructions thereon that, when executed by one or more processors, cause the one or more processors to:
receive decision data indicating decisions for transportation of cargo from one or more originating locations to one or more destination locations by one or more vehicles, wherein the one or more vehicles are configured to transport between the one or more originating locations and the one or more destination locations by operating one or more tractive components of the one or more vehicles;
generate a plurality of scenarios, by:
generating a baseline scenario including a plurality of decisions indicated by the decision data;
performing a plurality of modifications to the baseline scenario by making one or more adjustments to the plurality of decisions of the baseline scenario; and
saving the modifications of the baseline scenario as the plurality of scenarios;
determine emissions production resulting from the plurality of scenarios;
generate one or more updates to the transportation based on the plurality of scenarios and the emissions production resulting from the plurality of scenarios; and
output the one or more updates to the transportation to an output device.

2. The system of claim 1, wherein the instructions cause the one or more processors to:
generate data that programs one or more autonomous or semi-autonomous vehicles causing the one or more autonomous or semi-autonomous vehicles to perform the transportation.

3. The system of claim 1, wherein the instructions cause the one or more processors to:
generate a user interface including the one or more updates; and
cause a display device of a user device to display the user interface.

4. The system of claim 1, wherein the instructions cause the one or more processors to perform the plurality of modifications to the baseline scenario by adjusting:
fuel or energy types;
fuel sources including at least one of private fuel sources or public fuel sources;
transportation types including at least one of truck transportation, air transportation, boat transportation, or rail transportation;
transportation equipment indicating a type of equipment used to carry the cargo; and
transportation equipment fill indicating an amount of the cargo included within transportation performed with the transportation equipment.

5. The system of claim 1, wherein the instructions cause the one or more processors to generate a digital twin based on the decision data, the digital twin representing the baseline scenario;
wherein the instructions cause the one or more processors to perform the plurality of modifications to the baseline scenario by modifying the digital twin.

6. The system of claim 1, wherein the emissions production is a total emissions indicating operational emissions, feedstock emissions, and fuel production emissions.

7. The system of claim 1, wherein the emissions production is an emissions intensity.

8. The system of claim 1, wherein the instructions cause the one or more processors to:
receive a scenario that includes an update to one or more of the decisions of the baseline scenario, wherein the update is based on a user input; and
identify a particular emissions production resulting from the scenario.

9. The system of claim 1, wherein the instructions cause the one or more processors to:
receive an emissions level;
identify one or more scenarios of the plurality of scenarios that are associated with an emissions less than the emissions level; and
generate the one or more updates to the transportation based on the one or more scenarios identified that are associated with the emissions less than the emissions level.

10. The system of claim 1, wherein the instructions cause the one or more processors to:
determine, based on the decision data, one or more predicted actions of one or more carriers;
analyze the plurality of scenarios with the one or more predicted actions to determine the emissions production resulting from the plurality of scenarios; and
generate the one or more updates to the transportation based on the plurality of scenarios, the one or more predicted actions, and the emissions production resulting from the plurality of scenarios.

11. A method of vehicle transportation, comprising:
receiving, by a processing circuit, decision data indicating decisions for transportation of cargo from one or more originating locations to one or more destination locations by one or more vehicles, wherein the one or more vehicles are configured to transport between the one or more originating locations and the one or more destination locations by operating one or more tractive components of the one or more vehicles;
generating, by the processing circuit, a plurality of scenarios, by:
generating a baseline scenario including a plurality of decisions indicated by the decision data;
performing a plurality of modifications to the baseline scenario by making one or more adjustments to the plurality of decisions of the baseline scenario; and
saving the modifications of the baseline scenario as the plurality of scenarios;
determining, by the processing circuit, emissions production resulting from the plurality of scenarios;
generating, by the processing circuit, one or more updates to the transportation based on the plurality of scenarios and the emissions production resulting from the plurality of scenarios; and
outputting, by the processing circuit, the one or more updates to the transportation to an output device.

12. The method of claim 11, further comprising:
generating, by the processing circuit, data that programs one or more autonomous or semi-autonomous vehicles causing the one or more autonomous or semi-autonomous vehicles to perform the transportation.

13. The method of claim 11, further comprising:
generating, by the processing circuit, a user interface including the one or more updates; and
causing, by the processing circuit, a display device of a user device to display the user interface.

14. The method of claim 11, wherein performing, by the processing circuit, the plurality of modifications to the baseline scenario comprises adjusting:
fuel or energy types;
fuel sources including at least one of private fuel sources or public fuel sources;
transportation types including at least one of truck transportation, air transportation, boat transportation, or rail transportation;
transportation equipment indicating a type of equipment used to carry the cargo; and
transportation equipment fill indicating an amount of the cargo included within transportation performed with the transportation equipment.

15. The method of claim 11, further comprising:
generating, by the processing circuit, a digital twin based on the decision data, the digital twin representing the baseline scenario; and
performing, by the processing circuit, the plurality of modifications to the baseline scenario by modifying the digital twin.

16. The method of claim 11, wherein the emissions production is a total emissions indicating operational emissions, feedstock emissions, and fuel production emissions.

17. The method of claim 11, further comprising:
receiving, by the processing circuit, an emissions level;
identifying, by the processing circuit, one or more scenarios of the plurality of scenarios that are associated with an emissions less than the emissions level; and
generating, by the processing circuit, the one or more updates to the transportation based on the one or more scenarios identified that are associated with the emissions less than the emissions level.

18. The method of claim 11, further comprising:
determining, by the processing circuit, based on the decision data, one or more predicted actions of one or more carriers;
analyzing, by the processing circuit, the plurality of scenarios with the one or more predicted actions to determine the emissions production resulting from the plurality of scenarios; and
generating, by the processing circuit, the one or more updates to the transportation based on the plurality of scenarios, the one or more predicted actions, and the emissions production resulting from the plurality of scenarios.

19. One or more memory devices storing instructions thereon that, when executed by one or more processors, cause the one or more processors to:
receive decision data indicating decisions for transportation of cargo from one or more originating locations to one or more destination locations by one or more vehicles, wherein the one or more vehicles are configured to transport between the one or more originating locations and the one or more destination locations by operating one or more tractive components of the one or more vehicles;
generate a plurality of scenarios, by:
generating a baseline scenario including a plurality of decisions indicated by the decision data;
performing a plurality of modifications to the baseline scenario by making one or more adjustments to the plurality of decisions of the baseline scenario; and
saving the modifications of the baseline scenario as the plurality of scenarios;
determine emissions production resulting from the plurality of scenarios;
generate one or more updates to the transportation based on the plurality of scenarios the emissions production resulting from the plurality of scenarios; and
output the one or more updates to the transportation to an output device.

20. The one or more memory devices of claim 19, wherein the instructions cause the one or more processors to generate a digital twin based on the decision data, the digital twin representing the baseline scenario;
wherein the instructions cause the one or more processors to perform the plurality of modifications to the baseline scenario by modifying the digital twin.
